(19) United States
(12) Patent Application Publication
(10) Pub. No.: US 2017/0321737 A1
(43) Pub. Date: Nov. 9, 2017

(54) Non-Rotating Toggle Fastener

(71) Applicant: Terry Strackbein, Barboursville, VA (US)

(72) Inventor: Terry Strackbein, Barboursville, VA (US)

(21) Appl. No.: 15/149,498

(22) Filed: May 9, 2016

(51) Int. Cl. F16B 13/08

(52) U.S. Cl. CPC F16B 13/0808

(57) ABSTRACT

A non-rotating toggle fastener comprises a tubular body; a slidable interior nut; pivoting, spring activated, locking arms; and an escutcheon at the opposing end from the locking arms. The nut has a threaded interior over which a plastic insert is placed. The escutcheon has a flat proximal area extending beyond the perimeter of the body and threaded distal section that is recessed into the interior of the body. Preferably the body is a polygon to prevent rotation. Triangular shaped fins can extend on the exterior of the body from the escutcheon to the end of the body to prevent rotation. The pressure of threading a screw through the insert simultaneously slides the nut to a position adjacent the locking arms prior to the screw engaging the threaded interior perimeter. The toggle fastener can be manufactured from metal or a combination metal and plastic or composite.

### FIELD OF THE INVENTION

The invention relates to a toggle fastener that is prevented from rotation by fins and a polygonal body and locks the wall material between locking arms and an interior nut.

### BACKGROUND OF INVENTION

Various fasteners are available for use on existing walls and ceilings to quickly attach items such as cabinets, clocks, towel bars, hand railings, paintings, shelving, mirrors, light fixtures, and televisions. Known wall and ceiling fasteners include nails, screws, hooks, raptor anchors, molly bolts and toggle bolts. Most often the walls are made of drywall panels over a wood or steel stud framing where the studs are about two inches wide and sixteen inches apart. This stud framing produces 3½ inches deep hollow spaces beneath almost 90 percent of a drywall panel. In drywall-based ceilings, there is joist framing which produces 7½ inch deep hollow spaces beneath almost 90 percent of a ceiling drywall panel. Known fasteners can be used to securely attach a moderate weight household item but not to securely attach a heavy weight household item to drywall over a hollow space. Heavy household items, in particular cabinets loaded with dinner ware, and shelving loaded with books, need to be attached using long heavy duty nails or screws anchored in the wood framing. If a heavy item needs attachment to drywall over a hollow space, then the drywall can be opened up to add wood framing for fastening the heavy item, but this is a costly process.

Prior art drywall fasteners, such as raptor anchors, molly bolts and toggle bolts, have some installation problems. Molly bolts and raptor anchors need to be inserted into a tight drywall panel hole and have a screw that needs to be turned a number of times to deform the fastener behind the drywall panel into an anchor. Often, however, the fastener loosens in the drywall hole, and all strength is lost and the anchor is easily removed from the drywall. A toggle bolt has a nut with two spring-loaded toggle wings hinged to the nut. The tip of the toggle bolt shaft is inserted into the hole, then the toggle nut, and lastly the wide spring-loaded toggle wings with toggle wings springing open in the hollow space behind the drywall.

During installation, the ends of the toggle bolt wings point at all times to the inside surface of the drywall and cannot be removed if an error has been made. The toggle wings will only hook anchor to the inside face of the drywall without moving if the toggle bolt has been tightened down on the drywall sufficiently. The large panel hole permits the thin shaft of the toggle bolt to move sideways during installation, so it is necessary to repeatedly check the position of the item attached to the toggle bolt while the toggle bolt is tightened down onto the drywall. Also, when attaching a heavy weight item to drywall using a toggle bolt, the toggle bolt shaft can hang down at an angle from the drywall hole and slash the outside edge of the drywall hole. If a toggle bolt is over-tightened in the drywall, the toggle bolt wings may cut right through the drywall paper and crumble the gypsum plaster near the drywall hole. The installation may cause so much damage to the drywall that the toggle bolt wings will not anchor in the drywall. Thus, it is necessary with toggle bolts to support the weight of the heavy item while tightening the toggle bolt and then subsequently monitor the position of the item on the drywall for downward movements. If a toggle bolt is over-tightened to prevent movement, the hinging between the toggle wings and the nut may bend apart. When a toggle bolt is removed from a drywall hole only the toggle bolt shaft can be recovered without tearing up the hole. Accordingly, there is a need for a reliable, easy to install precise and stable, drywall fastener for attaching a heavy item to drywall over a hollow space.

### SUMMARY OF THE INVENTION

The present invention is directed to a non-rotating toggle fastener for mounting an article on a hollow wall comprising a tubular body having an interior perimeter, an exterior perimeter, a proximal end, and a distal end. A nut is dimensioned to be received slidably within the interior of the body and has a threaded interior perimeter dimensioned to receive a screw. An escutcheon is adjacent to the proximal end of the body with a proximal and distal section. The proximal section has a perimeter greater than the exterior perimeter of the body and the distal section is dimensioned to be received within the interior perimeter of the body and threaded to receive a screw. A pair of locking arms, having an interior surface and an exterior surface, are rotatably affixed to the distal end of the body by a pair of securing members. In some embodiments the locking arms have protrusions extending from the exterior surface to further grip the drywall. A torsion spring, positioned adjacent each of the locking arms, maintain said locking arms in a rest position approximately 90 degrees from the body. An insert, having a thickness in the range of about 0.0381 mm to about 0.78 mm and dimensioned to be received within the interior perimeter of said body, is placed adjacent the nut. The pressure of threading a screw through the insert simultaneously slides the nut to a position adjacent the locking arms prior to the screw engaging the 4 threaded interior perimeter of the nut.

At least one fin can be affixed, or contiguous, to the body. The fins have a first edge adjacent to the proximal edge of the body, extending from the escutcheon, to the distal end of the body to form a triangle. The first edge can have a perimeter equal to, greater than, or less than the perimeter of the escutcheon, to form a triangle.

In some embodiments a spring can be used between the escutcheon and the nut to maintain the nut adjacent the locking arms. The insert, if used, can be maintained in position adjacent the nut by the spring.

All components of the fastener, with the exception of the insert, can be manufactured from metal. When manufactured from plastic, the body, escutcheon and fins, if used, are contiguous. The nut can also be manufactured from plastic and can have a plastic cover over said interior perimeter having thickness to enable penetration by a screw once it is in contact with the locking arms.

To mount an article on a wall using a non-rotating fastener a hole is drilled into the drywall. The pair of locking arms at the distal end of the fastener are compressed and inserted into the hole. The body of the fastener is continued to be inserted until the proximal portion of the escutcheon is flush with the drywall. During insertion the fins on the body cut into the drywall to prevent rotation. The locking arms uncompress once they are through the drywall into the space beyond. A screw is threaded through threads at the distal section of the escutcheon, contacting the insert, cover, or nylon area of a lock nut. The pressure applied to thread the screw through to the threads within the nut forces the nut adjacent the locking arms. Once the threads on the nut are engaged, the drywall is locked between the locking arms and the nut.

### BRIEF DESCRIPTION OF THE DRAWINGS

These and other objects, features, advantages and aspects of the present invention can be better understood with reference to the following detailed description of the preferred embodiments when read in conjunction with the appended drawing figures.

FIG. 1 is a cutaway side view of the toggle fastener positioned to be inserted into drywall in accordance with the invention;

FIG. 2 is a cutaway side view of the toggle fastener within the drywall with the spring locking arms extended in accordance with the invention;

FIG. 3 is a cutaway side view of the toggle fastener square tubular body in accordance with the invention;

FIG. 4 is a top view of the toggle fastener showing the hollow, square tubing body, fins, nut and surrounding escutcheon in accordance with the invention;

FIG. 5 is a side view of the toggle fastener hollow square tubular body, spring and spring loaded locking arm in accordance with the invention;

FIG. 6 is a cutaway side view of the spring loaded arms and pivot pins within the square tubular body in accordance with the invention;

FIG. 7 illustrates an alternate embodiment of the invention wherein the spring loaded arms having nodules on the outer surface in accordance with the invention;

FIG. 8 illustrates the spring loaded arms of FIG. 7 affixed to a square tubular body in accordance with the invention;

FIG. 9 is a top view of a hexagonal body having a hexagonal nut in accordance with the invention;

FIG. 10 is a top view of a molded square tube body having a hexagonal interior in accordance with the invention;

FIG. 11 is a cutaway side view of a molded toggle fastener in accordance with the invention;

FIG. 12 is a top view of an alternate embodiment of the toggle fastener having an interior spring in accordance with the invention; and

FIG. 13 is a side view of the alternate embodiment of the toggle fastener of FIG. 12 in accordance with the invention.

### DETAILED DESCRIPTION OF THE INVENTION

### Definitions

As used herein the term “plastic” shall refer to any synthetic material made from a wide range of organic polymers such as polyethylene, PVC, nylon, etc., that can be formed, such as molded or extruded, into shape while soft and then set into a rigid or slightly elastic form.

As used herein the term “screw” shall refer to any threaded metal or wooden bar having a head and a tapered tip, that has threads capable of mating with a preformed internal thread. The head can be any design able to be tightened, including but not limited to hex, phillips, or flat head.

As used herein the term “composite” shall refer to a material made from two or more constituent materials with different physical or chemical properties that when combined produce a material different from the individual components.

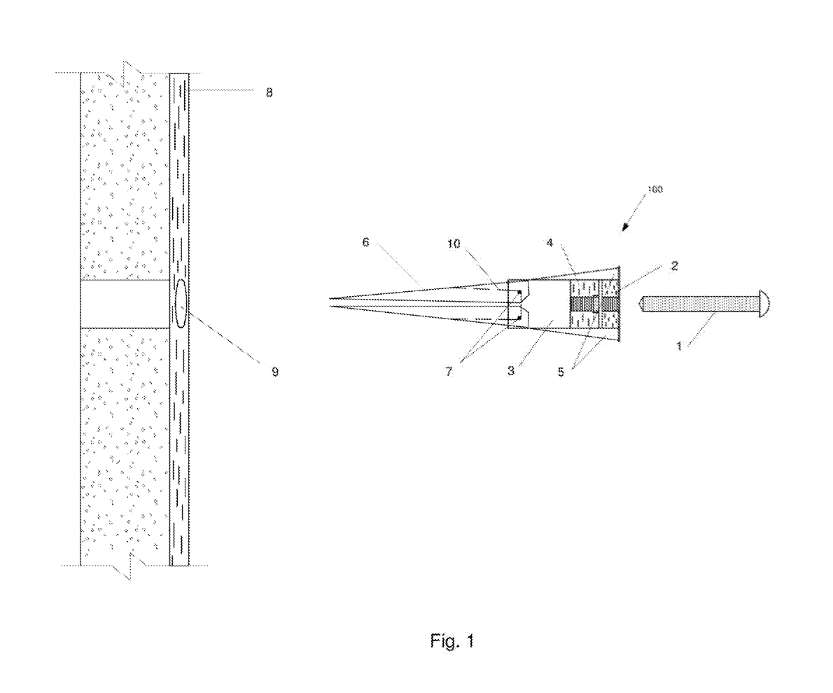

FIG. 1 illustrates the disclosed toggle fastener 100 in a ready to insert position. The hollow polygonal tubular body 3 of the fastener 100 has an interior dimensioned to receive a nut 4 that is in turn dimensioned to receive a tapered end screw 1, such as a machine screw. It is preferable that the body be a polygon to discourage rotation, however the body can be circular if combined with the fins disclosed hereinafter.

To prevent the nut 4 from tipping, thereby hampering threading, there should be minimal space between the perimeter of the nut and the interior diameter of the body. A slight friction fit is preferable, however the difference can be as great as 0.062 in (1.58 mm), and preferably 0.015 (0.39 mm) to 0.005 in (0.12 mm). The clearance is directly proportional to the height of the nut. For example, a nut with a height of 0.125 in. (3.175 mm) needs a clearance of around 0.008 in. (0.203 mm) to keep it from tipping. To a certain point, the taller the nut, the greater the allowable clearance. However, at some point the clearance between the nut and the interior of the body would diminish the screw's centering ability. Clearance is therefore dependent upon the dimensioning of the nut and the body, with a 0.124 in. (3.175 mm) nut having less of a leeway in clearance than a 1.25 in. nut. The leeway between the nut and the interior diameter of the body will be discernible by those skilled in the art.

Both ends of the square tubular body are open with the nut 4 being received in a first end and the spring loaded locking arms 6 being received in a second end. The nut 4 in this embodiment is a locking nut having a nylon insert that has been reversed from its usual use so that the screw 1 contacts the non-threaded nylon portion of the nut first, allowing it to move through the body before starting to thread. Once the nut 4 starts to thread all forward movement stops.

The starting placement of the nuts illustrated herein is dependent on the type of nut being used, whether the insert is adhered to the nut, a separate unit, or if the spring disclosed hereinafter is used. In embodiments where there is a tight friction fit between the nut and the interior of the body, with the starting position of the nut adjacent to the escutcheon, the insert can be a separate unit. In embodiments where the nut is spaced from the escutcheon, the insert should be adhered to the nut to prevent tipping. As the insert is a lightweight unit, it will tend to tip if there is sufficient space and therefore must be either adhered to the nut or retained in position by either a spring or placement adjacent the escutcheon.

Due to the criticality of the fit between the nut 4 and the interior of the body 3, any variation in screw sizing will most likely need to be tapped at the time of manufacture. Depending on the interior diameter of the body 3, it is possible that some nuts will be interchangeable.

An escutcheon 2, described in more detail further hereinafter, covers the first end of the square tubular body 3 serving to prevent the loss of the nut 4, support one end of the stabilizing fin 5 and to provide additional surface against the drywall. The additional surface area of the escutcheon 2 against the drywall prevents the screw 1 from sinking into the drywall when tightened.

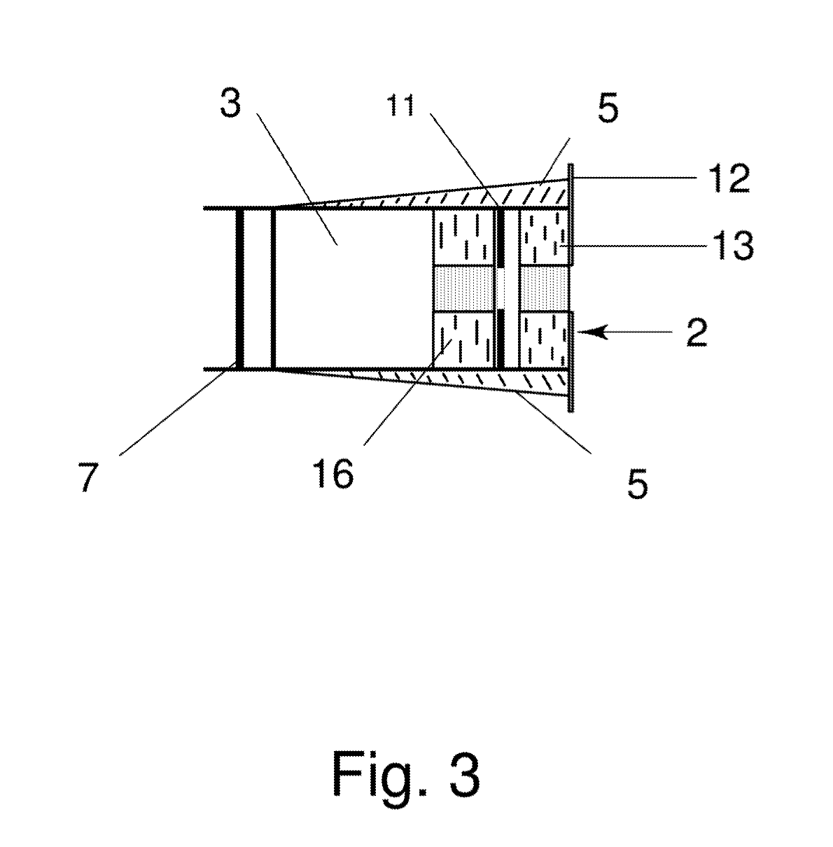

Extending from the corners of the square tubular body 3 are stabilizing fins 5. The stabilizing fins 5 are scalene triangles having a first side formed by the escutcheon 2, a second side formed by the body 3 in a right angle to the escutcheon 2, and the third side forming a line from the escutcheon 2 to the end of the body 3. The first side of the stabilizing fin 5, adjacent the escutcheon 2, has a height that extends to a point short of the perimeter of the proximal section 12 of the escutcheon 2 (FIG. 3). This configuration enables the body 3 to cut into the drywall 8 during insertion, thereby preventing rotation of the body 3. With too small an extension, the fins 5 will not bite into the drywall a sufficient distance to prevent rotation; however, with too great an extension, and the toggle fastener 100 will be too difficult to insert. It should be noted that although the embodiment illustrated is a right angle scalene triangle, other polygons can be used and will be evident to those skilled in the art in conjunction with the disclosure herein.

At the second end of square tubular body 3 is the pair of spring loaded locking arms 6. The locking arms 6 rotate on pivot pins 7 and opened through use of wire springs 10. In their resting state the arms 6 are open.

The hole 9, drilled into the drywall 8, has a diameter slightly smaller than the diagonal of the body 3. As the hole 9 is round and the body 3 square, there will be gaps along the sides of the body 3 which are covered by the escutcheon 2.

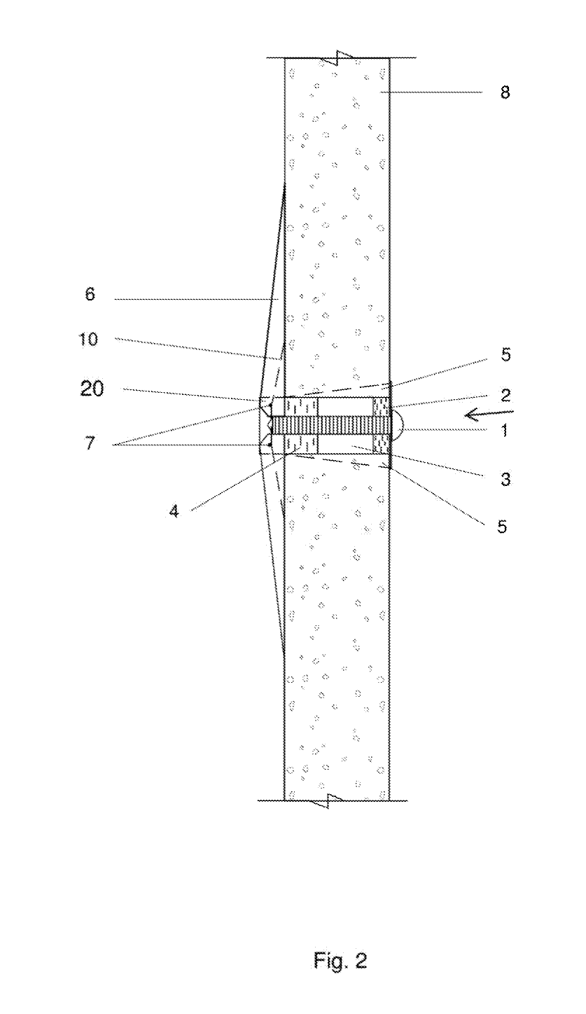

In FIG. 2 the locking arms 6 and body 3 have been inserted through the drywall to the point where the escutcheon 2 is in contact with the surface of the drywall 8. Once released from the confines of the drywall 8, the locking arms 6 are forced open by the wire spring 10, thereby contacting the back surface of the drywall 8. The screw 1 has been threaded into the locking nut 4 and screwed down to where the underside of head of the screw 1 abuts the escutcheon 2. As can be seen in this figure, the stabilizing fins 5 have cut into the drywall preventing rotation. The escutcheon 2 is resting against the drywall 8 and the nut 4 is adjacent to the proximal end 20 of the locking arms 6 proximate the pivot pins 7. The pressure exerted on the proximal end 20 of the locking arms 6 forces the locking arms 6 firmly against the drywall 8. Further, the number of threads, footprint and weight of the nut 4 provides greater stability and security from twisting or breaking, than prior art toggle screw fasteners. In FIG. 3 the interior of the body is more clearly shown. In this embodiment, a standard square nut 16 is used and a thin, non-threaded flexible plastic or composite insert 11 is placed over the threaded hole. The plastic insert 11 has a non-threaded hole slightly smaller than the screw 1 diameter, causing the nut 16 to pass through the body 3 ahead of the advancing screw 1. The insert 11 must have a thickness that allows the screw 1 to eventually thread through once the nut 16 is at its termination point.

In this way, the screw 1 first contacts the insert 11, being kept inline by the threads of the distal section 13 (FIG. 3) of the escutcheon 2, forcing the nut 16 toward the locking arms 6 until it contacts the locking arms 6. Once the nut 16 is in contact with the locking arms 6, the pressure of the screw 1 breaks through the insert 11 and engages the threads within the nut 16. The thickness of the plastic, or composite, insert 11 is in the range of about 0.381 mm (0.015 in) to about 0.78 mm (0.031 in) and preferably about 0.381 mm (0.015 in). More important than the thickness of the plastic is the flexural strength of the plastic being used. As the insert 11 is being used to move the nut 16 to a position adjacent the locking arms 6, the insert 11 must have some resistance to being pierced by the screw 1. Once pierced however, plastic entering the threads of the nut 16 can prevent all threads within the nut 16 being engaged by the screw 1. A more rigid insert 11 will enable the tip of the screw 1 to burrow through, subsequently engaging the threads within the nut 16.

The escutcheon 2 has a proximal section 12 and a distal section 13 with the proximal section 12 having a flush outer surface. The escutcheon illustrated in detail in FIG. 3 is a single unit having a thickened, threaded portion at the distal section 13. Alternatively, depending on manufacturing preference, the escutcheon 2 can be two pieces affixed to the square tubular body 3. The distal section 13 extends from the threaded hole in the nut 16 to the inner wall of the tubular body 3. The proximal section 12 extends to, or beyond depending on end use, the edge of the stabilizing fins 5. The distal section 13 of the escutcheon 2 is manufactured with starting threads to make the threading of the screw 1 easier. To keep the outer surface of the escutcheon 2 flush, the distal section 13 extends down and into the tubular body 3. Although thickness of the proximal section 12 is not critical, and can vary with end use, the thickness of the proximal section 12 should be kept to the minimum necessary to provide support and to avoid unnecessary protrusion beyond the drywall 8. The exact thickness of the proximal section 12 is dependent upon the material used, plastic, composite, or metal; the diameter of the body and escutcheon; as well as the weight of the object being supported. For general household use, a thickness of about 0.38 mm (0.015 in) can be used although this is depending on the foregoing factors and the appropriate thickness will be determinable by those skilled in the art in conjunction with the teachings herein.

In some embodiments the manufactured escutcheon 2 can be replaced by a flange nut having a flange with a diameter sufficient to rest on the square tubular body. The flange nut will provide the initial threading for the screw.

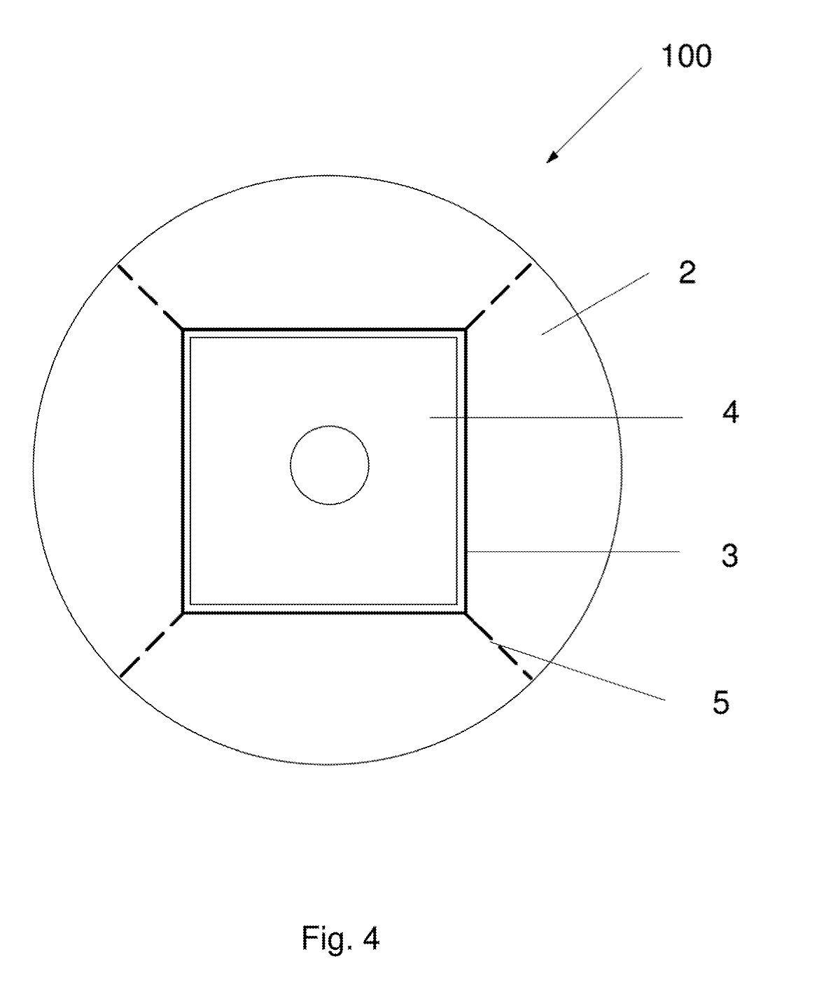

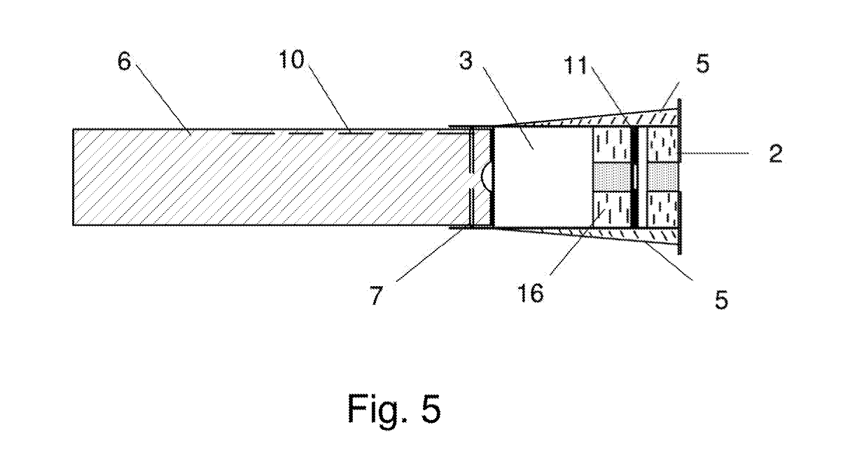

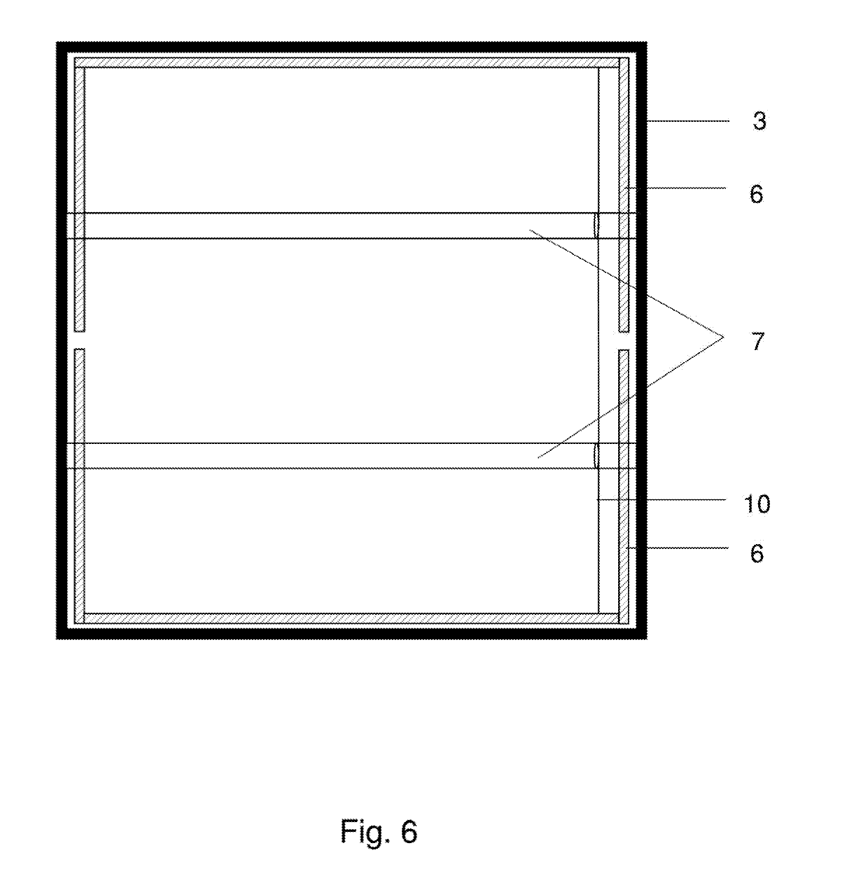

The top of the fastener 100 is illustrated in FIG. 4 further illustrating the relationship between the square tubular body 3, nut 4, fins 5 and escutcheon 2. In FIG. 5 the fastener 100 is in the closed, ready to insert position. FIG. 6 provides more detail on the interaction between the pivot pins 7, and wire spring 10 with the pivot pin 7 and wire spring 10 more clearly illustrated in detail. Alternatively, the spring can be located between the locking arms and the body, as with solid plastic or composite locking arms, or any other location convenient for manufacture.

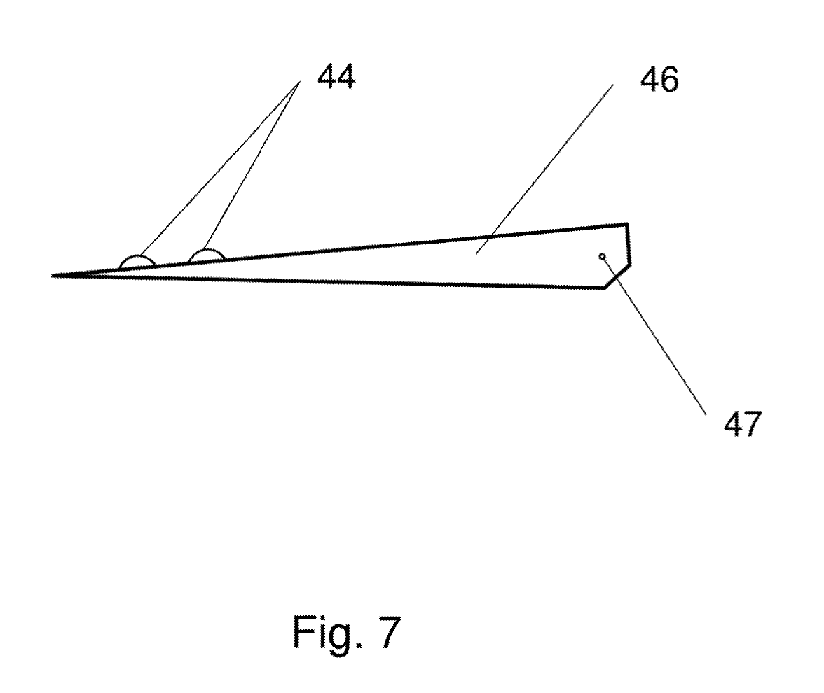

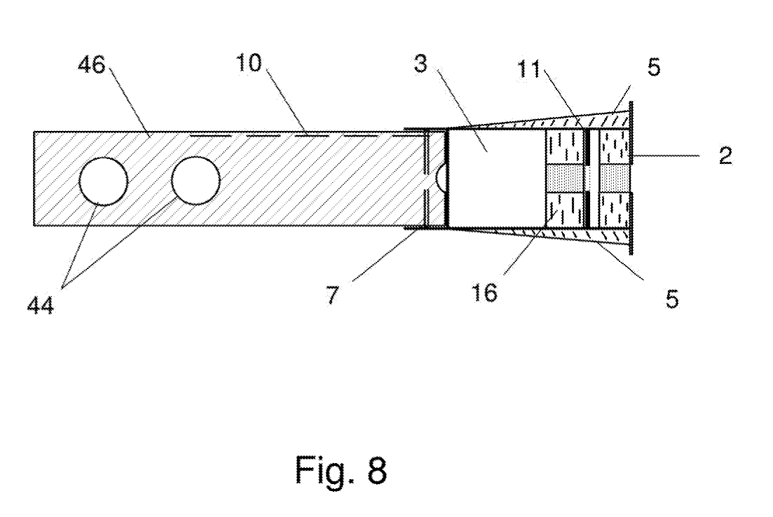

In FIGS. 7 and 8, an alternate embodiment is illustrated wherein the locking arms 46 contain protrusions 44 that extend above the surface of the locking arm 46. The protrusions 44 illustrated herein are half spheres, however any other configuration can also be used. The protrusions 44 are forced into the drywall by the locking nut 4 or 16 to provide additional grip. As seen in FIG. 8, the locking arms 46 connect to, and interact with, the body 3 as described heretofore.

The spring loaded locking arms 6, 46, are at rest in the open position. To insert into the predrilled hole in drywall, the arms 6, 46 are compressed and inserted, along with the body 3. Once the body 3 contacts the drywall 8, the fins 5 start cutting into the drywall 8 until the proximal section 12 of the escutcheon 2 contacts the drywall 8 surface. Once the locking arms 6, 46 are clear of the drywall 8, they unfold to contact the back surface of the drywall 8. When the proximal section 12 of the escutcheon 2 is in full contact with the drywall 8, the screw 1 is inserted and screwed in, pushing the nut 4, 16 down to contact the surface of the drywall 8. As the nut 4, 16 is tightened the locking arms are pulled in and pinned against the drywall 8.

The use of a hexagonal nut within a square body is not optimal as the points of contact are only two points of the nut. It is preferable to use a hexagonal body with the hexagonal nut as illustrated hereinafter. Alternatively, a rectangular body can be used with a hexagonal nut. Two sides of the nut would contact opposing interior sides of the rectangular body with the points of the hexagon contacting the remaining two sides of the rectangular body. The dimensioning between the hexagon nut and the interior of the rectangular body would be critical. Alternative a square nut could be used with the rectangular body with two sides contacting the sides of the body in a friction sufficient to prevent tilting while enabling movement under the pressure required to screw in a screw. To ensure that a square nut will not tip within a rectangular body, a spring, as disclosed hereinafter, can be used in addition to the friction fit.

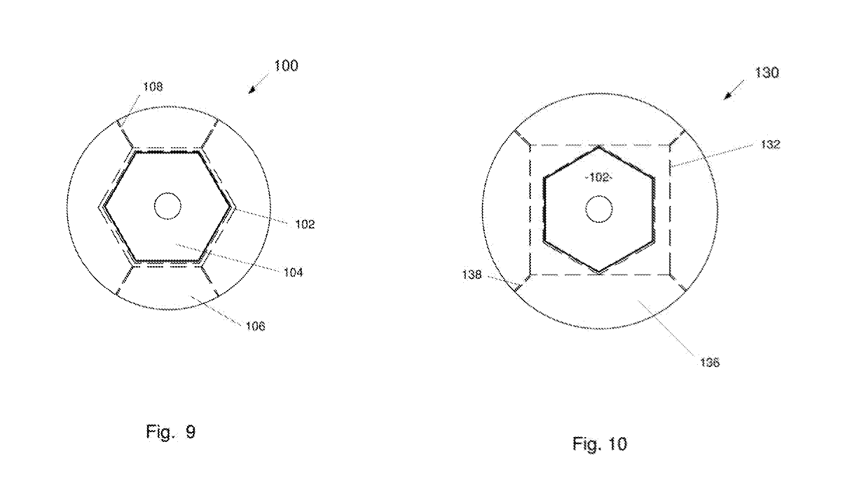

In FIG. 9 the top of the toggle fastener 100 has a hexagonal body 102 that receives a hexagonal nut 104. The hexagonal tube body 102 can be manufactured from plastic, composite or metal with an interior dimensioned to receive either custom or off the shelf nuts 104. Standard hexagonal nylon lock nuts are inexpensive and easily accessible and can be used with the hexagonal tubing 102 when the dimensioning is appropriate. Alternatively, plastic or composite nuts can be manufactured to the dimensions of the interior hexagonal tubing.

The nut 104 as illustrated is, or is the equivalent to, a standard nylon lock nut thereby eliminating the need for a nylon insert. By placing a nylon lock nut 104 into the hexagonal body 102 with the nylon threaded portion facing the user as the point of entry, the act of threading the screw 1 into the lock nut 104 forces it down to the locking arms (not shown).

The escutcheon 106 in this illustration is circular, however other shapes can be used based on manufacturing preferences. The fins 108 extend from at least two, and preferably four, points of the hexagon and provide support for the escutcheon 106 as well as prevent rotation. Although the fins are not a requirement to the disclosed toggle, they do serve to prevent rotation and are beneficial in many applications. However, in applications where rotation is not a concern and/or the material receiving the toggle fastener is rigid, the fins can be eliminated.

In FIG. 10 the plastic tubular body 132 of the toggle fastener 130 has a square outer diameter and a hexagonal inner diameter and is generally either molded or extruded. The hex nut 102 is, as noted in FIG. 9, either commercial or specifically designed to fit within the inner diameter of the body 132. As also noted above, the escutcheon 136 can be circular, as illustrated, or any other applicable shape. The fins 138 in this figure are not as critical as in FIG. 9 as there is more contact between the escutcheon 136 and the body 132 and therefore more support.

When the toggle fastener is manufactured from a plastic or composite, the screw being used can be self-tapping. This would allow the screw to self-tap through the escutcheon and locking nut creating additional pressure against the locking arms.

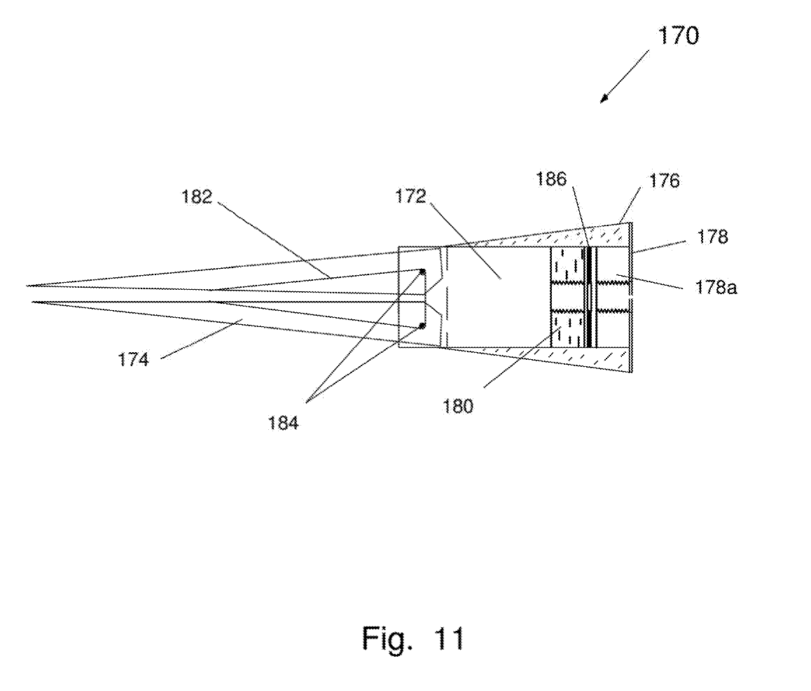

In FIG. 11 the side view of a molded toggle fastener 170 is illustrated. The body 172 can have any of the interior and exterior configurations as illustrated and/or described heretofore. In this embodiment the body 172, escutcheon 178, escutcheon distal portion 178a and fins 176 are a single unit, generally manufactured through molding or a combination of molding and extrusion. The plastic insert 186 can be a separate piece, as illustrated, or can be an extension of the distal portion 178a. If an extension, the thickness of the insert 186 must be such that the screw can “thread through” to engage the threads of the nut 180 upon contact with the locking arms 174. In designs where a hexagonal nylon lock nut is used, as described heretofore, the plastic insert 186 can be eliminated. In this embodiment the locking arms 174 are manufactured from a plastic or composite capable of taking the forces to be applied. There are a number of applicable material and the selection will be known to those skilled in the art. The pivot pins 184 can be manufactured from plastic or metal, depending upon size and manufacturing preference. The spring 182 is manufactured from wire, or other material capable of meeting the criteria, having a sufficient gauge to separate the arms 174 and place them against the drywall.

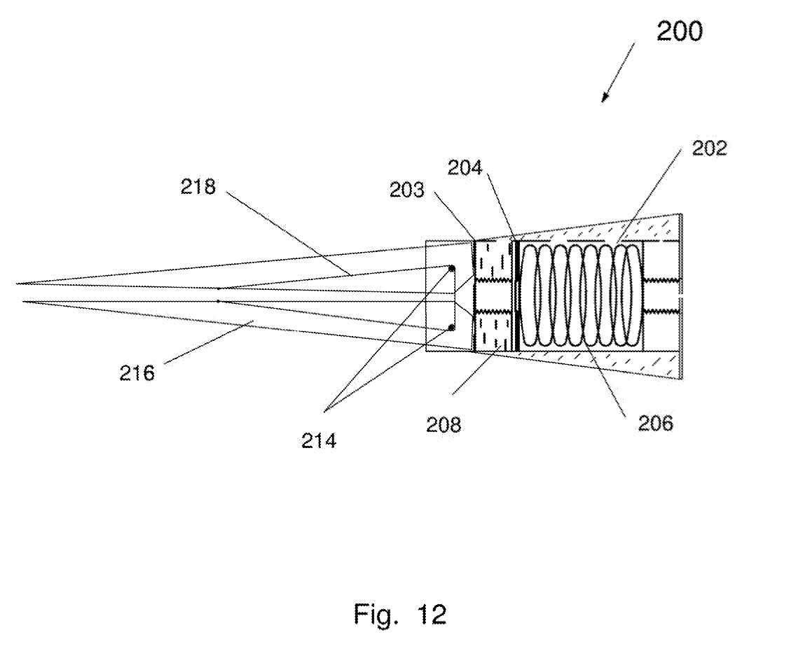

The toggle fastener 200 of FIG. 12 illustrates another embodiment using a spring 206 to maintain the nut 208 proximate the locking arms 216. As with the toggle fastener 170 of FIG. 11, the body 202, including escutcheon and fins, is manufactured from plastic. The plastic insert 204 is adjacent the nut 208, both of which are at the distal end 203 of the body. The spring 206 maintains the plastic insert 204 and nut 208 in position, preventing tilting. This provides a greater leeway between the interior sizing of the body 202 and the exterior sizing of the nut 208.

The spring 218, locking arms 216 and pivot pins 214 are manufactured as noted above. Additionally, as described with respect to FIG. 11, when a nylon lock nut is used, the insert 204 can be eliminated or manufactured as part of a plastic nut.

When a plastic nut is used, in this or any other embodiment, a thread cover should be added, serving the same purpose as the insert previously disclosed. The thread cover must enable the screw to tap through the cover while pushing the nut adjacent to the locking arms and would, therefore have the same thickness and composition as were it a separate insert.

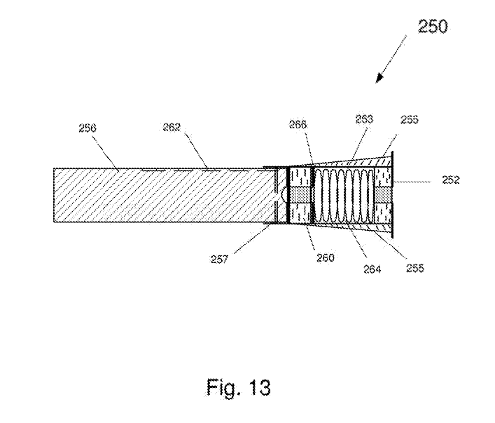

In FIG. 13 the toggle fastener 250 the fins 255, tubular body 253, locking arms 256, pins 257, wire spring 262 and escutcheon 252 are manufactured from metal as described heretofore. In this embodiment, a spring 264 is used to maintain the nut 260 adjacent the locking arms 256. As with prior embodiments, when a standard nylon lock nut, in reverse position, is used, the insert can be eliminated. Additionally, in some applications, as will be recognized by those skilled in the art in combination with the teachings here, the insert can be eliminated, as illustrated in FIG. 1.

### Example I

Body—0.25 in. perimeter, square tube giving a diagonal measurement of 0.343 in. and a wall thickness of 0.014 in.

Locking arms—0.218 in. square tube, wall thickness of 0.014 in. and length of 0.875 in.

Nut—0.206 in. nut tapped to receive an 6-32 screw

Plastic insert—having a 0.038 in. thickness

Drywall receiving hole—0.31 in.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about”. “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 10%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A non-rotating toggle fastener for mounting an article on a hollow wall, said toggle fastener comprising:
a body, said body being a tubular member comprising:
an interior perimeter;
an exterior perimeter;
a proximal end; and
a distal end;
a nut, said nut having:
an exterior perimeter dimensioned to be received slidably, without tipping, within said interior perimeter of said body; and
a threaded interior perimeter, said threaded interior perimeter dimensioned to receive a screw;
an escutcheon, said escutcheon being adjacent to said proximal end of said body and having:
a proximal section, said proximal section having a perimeter greater than said exterior perimeter of said body;
a distal section, said distal section being dimensioned to be received within said interior perimeter of said body and threaded to receive a screw;
a pair of locking arms, said locking arms being rotatably affixed to said distal end of said body by a pair of securing members and having an interior surface and an exterior surface;
a torsion spring, said torsion spring being positioned adjacent each of said pair of locking arms and said pair of securing members to maintain said locking arms in a rest position approximately 90 degrees from said tubular body.

2. The toggle fastener of claim 1 further comprising at least one fin, each of said at least one fin having a first edge adjacent to said proximal end of said body extending from said escutcheon to said distal end of said body to form a triangle, said first edge being one from the group comprising; a perimeter equal to said perimeter of said escutcheon; a perimeter less than said perimeter of said escutcheon; a perimeter greater than said perimeter of said escutcheon of said body.

3. The toggle fastener of claim 1 wherein said tubular body is a polygon with fins extending from at least one angle of said polygon, said fins having a first edge adjacent to said escutcheon and extending to said distal end of said body to form a triangle.

4. The toggle fastener of claim 1 further comprising an insert, said insert being dimensioned to be received within said interior perimeter of said body, adjacent said nut.

5. The toggle fastener of claim 4 wherein said insert has a thickness in the range of about 0381 mm to about 0.78 mm.

6. The toggle fastener of claim 4 wherein pressure of threading a screw through said insert simultaneously slides said nut to a position adjacent said locking arms prior to said screw engaging said threaded interior perimeter.

7. The toggle fastener of claim 1 wherein said locking arms further comprise at least one protrusion extending from said exterior surface.

8. The toggle fastener of claim 1 wherein said nut is adjacent said escutcheon prior to use and adjacent said locking arms once a screw is threaded through said threaded interior periphery.

9. The toggle fastener of claim 1 further comprising a spring, said spring being adjacent said distal portion of said escutcheon to maintain said nut adjacent said locking arms.

10. The toggle fastener of claim 8 further comprising an insert, said inert being adjacent said nut and maintained in position by said spring.

11. The toggle fastener of claim 1 wherein said toggle fastener is metal.

12. The toggle fastener of claim 1 wherein said toggle fastener plastic.

13. The toggle fastener of claim 2 wherein said toggle fastener is plastic.

14. The toggle fastener of claim 12 wherein said body, said escutcheon and said fins are contiguous.

15. The toggle fastener of claim 11 wherein said body and said escutcheon are contiguous.

16. The toggle fastener of claim 1 wherein said nut is plastic.

17. The toggle fastener of claim 15 wherein said nut further comprises a plastic cover over said interior perimeter having thickness to enable penetration by a screw once said nut is adjacent said locking arms.

18. A non-rotating toggle fastener for mounting an article on a hollow wall, said toggle fastener comprising:
a body, said body being a tubular member comprising:
a polygonal interior perimeter;
a polygonal exterior perimeter;
a proximal end; and
a distal end;
a nut, said nut having:
an exterior perimeter dimensioned to be received slidably with said interior perimeter of said body; and
an interior perimeter, said interior perimeter threaded to receive a screw;
an escutcheon, said escutcheon being adjacent to said proximal end of said body and having:
a proximal section, said proximal section having a perimeter greater than said exterior perimeter of said body;
a distal section, said distal section being dimensioned to be received within said interior perimeter of said body and threaded to receive a screw;
at least one fin, each of said at least one fin having a first edge adjacent to said proximal end of said body extending from said escutcheon to said distal end of said body to form a triangle, said at least one fin cutting into said hollow wall during insertion of said body into a predrilled hole.
an insert, said insert being dimensioned to be received within said interior perimeter of said body, adjacent said nut.
a pair of locking arms, said locking arms being rotatably affixed to said distal end of said body by a pair of securing members and having an interior surface and an exterior surface;
a torsion spring, said torsion spring being positioned adjacent each of said pair of locking arms and said pair of securing members to maintain said locking in a rest position approximately 90 degrees from said tubular body.

19. The toggle fastener of claim 1 further comprising a spring, said spring being adjacent said distal section of said escutcheon to maintain said nut adjacent said locking arms.

20. The method of mounting an article on a wall using a non-rotating fastener comprising the steps of:
drilling a hole in drywall;
compressing a pair of locking arms at a distal end of said fastener;
inserting said locking arms into said hole;
continuing to insert a polygonal body of said fastener until a proximal end of an escutcheon is proximate said drywall, fins on said body cutting into said drywall to prevent rotation and said locking arms are in an uncompressed position;
threading a screw through a threaded distal section of said escutcheon;
contacting an insert between said distal section of said escutcheon and a nut;
threading said screw into said insert and pushing said nut adjacent said locking arms;
threading said screw into said nut;
locking said drywall between said locking arms and said nut.
